(19) United States
(12) Patent Application Publication
(10) Pub. No.: US 2012/0237163 A1
(43) Pub. Date: Sep. 20, 2012

(54) PHOTONIC CRYSTAL BASED MULTI-CHANNEL ROTARY JOINT FOR ELECTRO-MAGNETIC SIGNALS

(76) Inventors: Louis D. VIOLANTE, Monroe Township, NJ (US); Boying B. Zhang, Lawrenceville, NJ (US); Hong Zhang, North Brunswick, NJ (US)

(21) Appl. No.: 13/050,711

(22) Filed: Mar. 17, 2011

(51) Int. Cl. G02B 6/26

(52) U.S. Cl. 385/26

(57) ABSTRACT

A multi-channel electro-magnetic rotary joint has been invented in which one or more electro-magnetic signals can be transmitted simultaneously from a rotating collimator array to a stationary collimator array, and vice-versa, in air and in other fluids. A photonic crystal based de-rotating mechanism is positioned in the path between said rotating collimator array and said stationary collimator array, and arranged for rotation relative to each collimator arrays at a rotary speed equal to one-half the relative rotational rate between said rotating and stationary collimator arrays. This invention has several different potential applications such radar, winches, and robotics to name a few.

### BACKGROUND OF THE INVENTION

A typical rotary joint consists of a fixed collimator holder and a rotatable collimator holder which are rotatable relative to each other allowing the uninterrupted transmission of electro-magnetic signals through the rotational interface from collimators on any one of the holders to the collimators on the other holder.

A multi-channel fiber optic rotary joints typically utilize a de-rotating mechanism between the fixed collimator holder and the rotatable collimator holder. The optic de-rotating mechanism can be Dove prism, Delta prism, Abbe-Konig prism, and Schmidt-Pechan prism, which rotates at half the speed of rotation of the rotatable fiber collimator holder.

The examples of the prior arts include U.S. Pat. No. 4,109,998 (Dove prism), U.S. Pat. No. 4,460,242, U.S. Pat. No. 5,271,076 (Dove prism), U.S. Pat. No. 7,373,041 (Dove prism & Abbe-Konig prism) and US 2007/0019908 (Schmidt-Pechan prism & Abbe-Konig prism).

U.S. Pat. No. 4,109,998 rotary joint utilizes a Dove prism as a de-rotation mechanism to de-rotate the images of an input set of optic transmitters located on the rotor, so that they may be focused onto stationary photo detectors located on the stator. De-rotation is accomplished by gearing the rotor and the prism in such a way that the prism rotates half as fast as the rotor. The optical rotary joint in U.S. Pat. No. 4,109,998 utilize light emitting diodes (LEDS) or lasers and laser detectors instead of optic fibers. As a result, it does not require the high alignment accuracy required for optic fibers, because the detectors may be quite large. The device is not bidirectional.

U.S. Pat. No. 4,460,242 discloses an optic slip ring employing optical fibers to allow light signals applied to any one or all of a number of inputs to be reproduced at a corresponding number of outputs of the slip ring in a continuous manner. It includes a rotatable output member, a stationary input member and a second rotatable member which is rotated at half the speed of the output member like a de-rotator. The input member having a plurality of equi-spaced light inputs and the output member having a corresponding number of light outputs and the second rotatable member having a coherent strip formed of a plurality of bundles of optical fibers for transmitting light from the light inputs on the input member to the light outputs.

Most of the prior arts with de-rotating mechanisms can only be used in air because fluids, having similar index of refraction to glass, would render the de-rotating mechanisms, such as a Dove Prism, useless. Additional they are limited to use in optics or the visible part Of the electro-magnetic spectrum.

Photonic crystals are composite materials composed of regularly repeating regions of relatively high and low dielectric materials. This periodic structure affects the propagation of electro-magnetic waves by prohibiting the propagation of certain electro-magnetic waves and allowing the propagation of others. This gives rise to certain phenomena such as high reflective omni-directional mirrors and waveguides. However, un-like traditional mirrors this phenomenon is based on refraction and can be used for any wavelength along the entire electro-magnetic spectrum. Further since it is based on refraction periodicity of the photonic crystal is based on the wavelength of interest. These properties are very important in reducing the power loss exhibited by an electro-magnetic signal as it travels through the de-rotating mechanism.

Photonic Crystals are general referred to a one, two or three dimensional depending on the number of Cartesian direction that the crystal displaced aperiodic structure. Therefore, a one-dimension photonic crystal would only display periodicity in one of the Cartesian directions. A two dimensional photonic crystal would display periodicity in two of the Cartesian directions and a three dimensional photonic crystal would display periodicity in three of the Cartesian directions. The importance of this is the unique properties of a photonic crystal only occur when an electrometric signal is traveling in the direction of the periodicity. For example if a one dimensional photonic crystal is periodic in the x direction then it only exhibits the qualities of a photonic crystal when the electro-magnetic signal is traveling within a plane that contains the x-axis but is perpendicular to both the y and z axes.

### SUMMARY OF THE INVENTION

The object of the present invention is to utilize a photonic crystal de-rotating mechanism to realize a multi-channel electro-magnetic rotary joints which can simultaneously transmit one or more electro-magnetic signals through a single mechanical rotational interface with a very low-profile which could be used in air and other fluids.

### BRIEF DESCRIPTION OF THE DRAWINGS

FIG. 1—Is the schematic drawing of de-rotating Dove prism.

FIG. 2—Is an outline diagram a three dimensional photonic crystal de-rotating mechanism in the present invention.

FIG. 3—Illustrates the principles of a three dimensional photonic crystal de-rotating mechanism for a multi-channel electro-magnetic rotary joint in the present invention.

FIG. 4—Depicts the position three dimensional photonic crystal de-rotating mechanism relative to a stationary collimator array and a fiber collimator array in the present invention.

FIG. 5—Is a cross-sectional view of a multi-channel electro-magnetic rotary joint in the present invention.

### DETAILED DESCRIPTION OF THE INVENTION

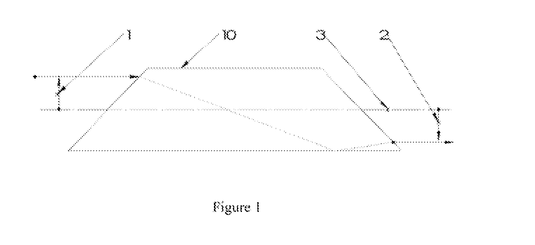

Dove prisms are used to invert an image and when they are rotated along their longitudinal axis, the transmitted image rotates at twice the rate of the prism (see FIG. 1). Therefore, if the prism rotates at half the rate of a rotating object, the image after passing through the prism will appear to be stationary. FIG. 1 is the schematic drawing of de-rotating Dove prism in the prior art. The image (2) of an object (1) is inverted by the Dove prism (10). Furthermore, if the prism (10) is rotated about the optic axis (3), the image (2) rotates at twice the rate of rotation of Dove prism (10).

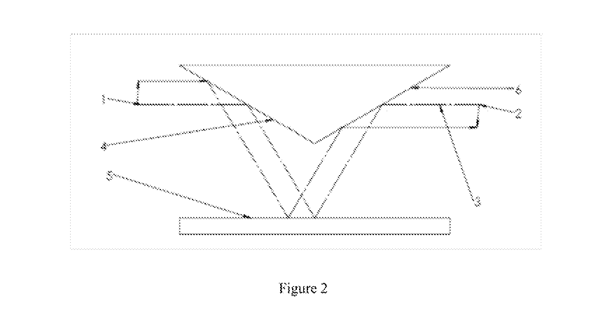

FIG. 2 illustrates the principle of a three dimensional photonic crystal de-rotating mechanism in the present invention. The image (2) of an object (I) on the entrance side is redirected by the First face of a three dimensional photonic crystal (4) toward another three dimensional photonic crystal (5) which in-turns redirection the image to the second face of the first three dimensional photonic crystal (6). This second face of the first three dimensional photonic crystal (6) redirects the image out the exit of the de-rotating mechanism resulting in an inverted in a similar way as the Dove prism (10) in FIG. 1. However, there are a few critical differences. Since the three dimensional photonic crystal can be engineered for any wavelength along the entire electro-magnetic spectrum this device is not limited to the optical range of the spectrum. Also, since photonic crystals are near perfect and the wave propagates through one medium the signal exhibits significantly less power loss. Two-dimensional or one dimensional photonic crystals can be used in the same way with the same results as a three dimensional photonic crystal. Except if one dimensional photonic crystals are used each face of the first three dimensional photonic crystal, (4) and (6) respectively, shall be a one dimensional photonic crystal.

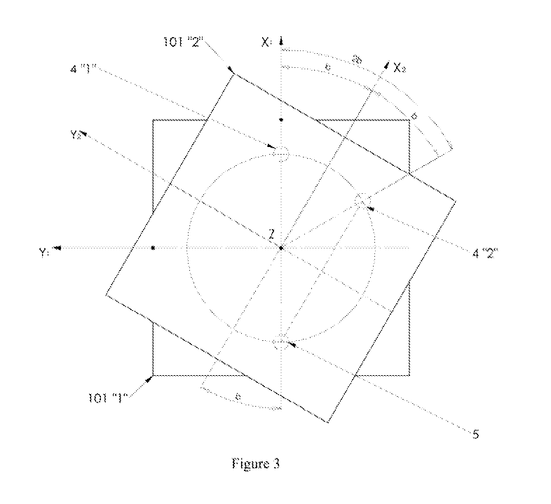

FIG. 3 depicts how the three dimensional photonic crystal de-rotating mechanism (101) can be used for a multi-channel electro-magnetic rotary joint in the present invention. Suppose the three dimensional photonic crystal dc-rotating mechanism (101) rotates an angle “b” around its axis “Z” from position “1” to position “2”, e.g., from 101 “1” to 101 “2”. The co-ordinates of the object (4) in position “1”, e.g., 4 “1”, is (X1, Y1). According to FIG. 2, because the image (5) is inverted symmetrically relative to the axis “Z”, the co-ordinates of the image (5) in position “1” are (—X1, Y1). If the object rotates an angle “2b” around axis “Z” in the same direction as the three dimensional photonic crystal de-rotating mechanism (101), the co-ordinates of the object (4) in position “2”, e.g., 4 “2”, are (X2, Y2). It's easy to get that co-ordinates of the image (5) in position “2” are (−X2, Y2). So the absolute position of the image (5) remains the same before and after the rotation. That means that if the three dimensional photonic crystal de-rotating mechanism (101) rotates at half the speed of a rotating object (4), its image (5) after passing through the three dimensional photonic crystal de-rotating mechanism (101), will remain to be stationary. Two-dimensional or one dimensional photonic crystals can be used in the same way with the dame results as a three dimensional photonic crystal. Except if one dimensional photonic crystals are used each face of the first three dimensional photonic crystal, shall be a one dimensional photonic crystal.

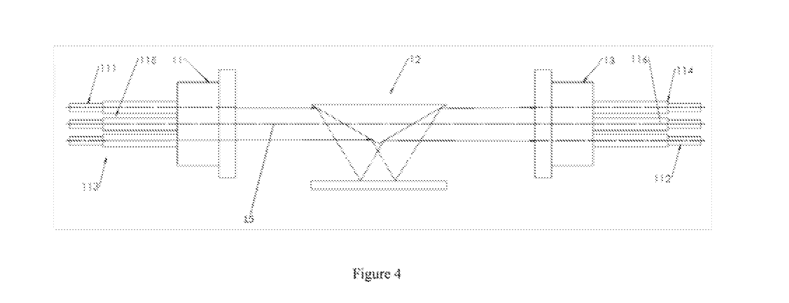

In FIG. 4, a three dimensional photonic crystal de-rotating mechanism (12) in the present invention is positioned between a stationary collimator array (13) and a rotary collimator array (11). The rotary collimator array (II), the stationary collimator array (13) and the three dimensional photonic crystal de-rotating mechanism (12) are rotatable around a common axis (15). All the collimators (111, 112, 113, 114, 115, 116 . . . ) in said stationary collimator array (13) and said rotary collimator array (11) are arranged parallel to the common axis (15). If three dimensional photonic crystal de-rotating mechanism (12) rotates at half the speed of rotation of said rotary collimator array (11) around the common axis (15), the electro-magnetic signals from the rotary collimator array (11) would be passed through the three dimensional photonic crystal de-rotating mechanism (12) and transmitted to the related channel of the stationary collimator array (13) respectively, e.g., the first channel electro-magnetic signal can be transmitted between collimator (111) and (112); the second channel electro-magnetic signal can be transmitted between collimator (115) and (116); the third channel electro-magnetic signal can be transmitted between collimator (113) and (114), so as to provide a continuous, bi-directional, multi-channel electro-magnetic signal transmission between two collimator arrays. Two-dimensional or one dimensional photonic crystals can be used in the same way with the dame results as a three dimensional photonic crystal. Except if one dimensional photonic crystals are used each face of the first three dimensional photonic crystal, shall be a one dimensional photonic crystal.

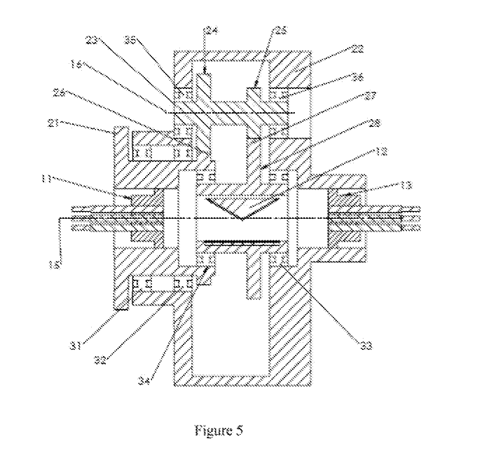

FIG. 5 depicts one of embodiments of a multi-channel electro-magnetic rotary, joint of the present invention. A speed reduction mechanism includes gears (24, 25, 26, and 27) in which two gears (26 and 27) are rotatable around the common axis (15), while the other two gears (24 and 25) are rotatable around a parallel axis (16). The gear ratio i from gears 26 to gear 27 can be determined as follows:

$$i = \frac{{Z}_{24} {Z}_{27}}{{Z}_{26} {Z}_{25}}$$

where, Z₂₄, Z₂₅, Z₂₆ and Z₂₇ are the number of gear teeth number for gears 24, 25, 26 and 27 respectively. If the gear ratio i=2:1, that means gear 27 will rotate at half the speed of the rotation of gear 26.

As illustrated in FIG. 5, the three dimensional photonic crystal de-rotating mechanism (12), the stationary collimator array (13) and the rotary collimator array (11) are fixed in the center of the cylinder (28), the stator (22) and the rotor (21). The relative position between the three dimensional photonic crystal de-rotating mechanism (12), the stationary collimator array (13) and the rotary collimator array (11) are the same as depicted in FIG. 4. The rotor (21) is part of a gear (26), which is rotatable relative to the stator (22) through the bearings (31 and 32). The cylinder (28) is part of a gear (27), which is rotatable relative to the stator (22) through the bearings (32 and 34). Two gears (24 and 25) are physically connected to the common shall (23), which is rotatable around the parallel axis (16) relative to the stator (22) through two bearings (35 and 36). As stated above, the gear ratio i=2: I would assure that the three dimensional photonic crystal de-rotating mechanism (12) will rotate at half the speed of the rotation of the rotary collimator array (11). Two-dimensional or one dimensional photonic crystals can be used in the same way with the dame results as a three dimensional photonic crystal. Except if one dimensional photonic crystals are used each face of the first three dimensional photonic crystal, (4) and (6) respectively, shall be a one dimensional photonic crystal.

What is claimed is:

1. A multi-channel electro-magnetic rotary joint for electro-magnetic signal transmissions comprising:
A first collimator array with a rotary axis;
A second collimator array with a rotary axis;
A photonic crystal de-rotating mechanism; and
Said first collimator array and said second collimator array are aligned with said rotary axes and relatively rotatable along said rotary axes and having a photonic crystal de-rotating mechanism positioned in the path between said first collimator array and said second collimator array, wherein is arranged for rotation around said rotary axes relative to each of said first and second collimator arrays at a rotary speed equal to one-half the relative rotational rate between said first and second collimator arrays; and a speed reduction mechanism for providing the rotation between said photonic crystal de-rotating mechanism and said first and second collimator array to rotate the photonic crystal de-rotating mechanism at a rotational rate half the rotational rate of said first and second collimator array; wherein said speed reduction mechanism is a gear mechanism with gear ration of 2:1, or any other passive mechanical system.

2. For the multi-channel electro-magnetic rotary joint of claim 1, wherein said photonic crystal de-rotating mechanism is comprised of two three dimensional photonic crystals for the desired frequency range within the electro-magnetic spectrum with the first photonic crystal having two faces exposed to the electro-magnetic signal and the second photonic crystal having only one exposed face.

3. For the multi-channel electro-magnetic rotary joint of claim 2, wherein the electro-magnetic signal passes through the first collimator array is redirected by the first face of the first three dimensional photonic crystal toward the second three dimensional photonic crystal which in-turns redirection the signal to the second face of the first three dimensional photonic crystal and the second face of the first three dimensional photonic crystal redirects the signal towards the second collimator array which captures the signal.

4. For the multi-channel electro-magnetic rotary joint of claim 1, wherein said photonic crystal de-rotating mechanism is comprised of two two-dimensional photonic crystals for the desired frequency range within the electro-magnetic spectrum with the first photonic crystal having two faces exposed to the electro-magnetic signal and the second photonic crystal having only one exposed face.

5. For the multi-channel electro-magnetic rotary joint of claim 4, wherein the electro-magnetic signal passes through the first collimator array is redirected by the first face of the first two dimensional photonic crystal toward the second two dimensional photonic crystal which in-turns redirection the signal to the second face of the first two dimensional photonic crystal; and the second face of the first two dimensional photonic crystal redirects the signal towards the second collimator array which captures the signal.

6. For the multi-channel electro-magnetic rotary joint of claim 1, wherein said photonic crystal de-rotating mechanism is comprised of three one-dimensional photonic crystals for the desired frequency range within the electro-magnetic spectrum each having only one face exposed to the electro-magnetic signal.

7. For the multi-channel electro-magnetic rotary joint of claim 6, wherein the electro magnetic signal passes through the first collimator array is redirected by the first one-dimensional photonic crystal toward the second one dimensional photonic crystal which in-turns redirection the signal to the third one dimensional photonic crystal and the third one dimensional photonic crystal redirects the signal towards the second collimator array which captures the signal.

8. For the multi-channel electro-magnetic rotary joint of claim 1, wherein said photonic crystal de-rotating mechanism is comprised of one two-dimensional photonic crystal and one one-dimensional for the desired frequency range within the electro-magnetic spectrum with the two dimensional photonic crystal having two faces exposed to the electro-magnetic signal and the one dimensional photonic crystal having one face exposed to the electro-magnetic signal.

9. For the multi-channel electro-magnetic rotary joint of claim 8, wherein the electro-magnetic signal passes through the first collimator array is redirected by the first face of the two dimensional photonic crystal toward the one-dimensional photonic crystal which in-turns redirection the signal to the second face of the two dimensional photonic crystal and the second face of the two dimensional photonic crystal redirects the signal towards the second collimator array which captures the signal.

10. For the multi-channel electro-magnetic rotary joint of claim 1, wherein said photonic crystal de-rotating mechanism is comprised of one three-dimensional photonic crystal and one one-dimensional for the desired frequency range within the electro-magnetic spectrum with the three dimensional photonic crystal having two faces exposed to the electro-magnetic signal and the one dimensional photonic crystal having one face exposed to the electro-magnetic signal.

11. For the multi-channel electro-magnetic rotary joint of claim 10, where the electro-magnetic signal passes through the first collimator array is redirected by the first face of the three dimensional photonic crystal toward the one-dimensional photonic crystal which in-turns redirection the signal to the second face of the three dimensional photonic crystal and the second face of the three dimensional photonic crystal redirects the signal towards the second collimator array which captures the signal.
